(19) United States
(12) Patent Application Publication
(10) Pub. No.: US 2009/0228778 A1
(43) Pub. Date: Sep. 10, 2009

(54) METHOD AND APPARATUS FOR MARKING UP MULTIMEDIA IMAGES ELECTRONICALLY

(76) Inventor: Jeffrey R. Tannenbaum, Palo Alto, CA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/147,715

(22) Filed: Jun. 27, 2008

Related U.S. Application Data
(60) Provisional application No. 60/937,353, filed on Jun. 27, 2007.

(51) Int. Cl. G06F 17/00

(52) U.S. Cl. 715/233; 715/744

(57) ABSTRACT

Method and apparatus for accessing an image at an arbitrary website, and combining indicia and/or other items with the accessed image. The indicia/items may be available from a website of a service provider which stores the indicia/items for use by subscribers. The user accesses a website employing a presently available browser or an email reading application that supports HTML. Application software provided by the present invention is installed in the browser/email reader and includes directions for use to overlay an image at the target website. The possible combinations of images and overlay(s) are limited only by the creativeness of the user.

### CROSS REFERENCE TO RELATED APPLICATION

This application claims the benefit of U.S. Provisional Application No. 60/937,353, filed Jun. 27, 2007, which is incorporated by reference as if fully set forth.

### FIELD OF THE INVENTION

The present invention relates to obtaining and viewing images obtained through the internet and more particularly to novel method and apparatus for accessing images at substantially any targeted website and overlaying the accessed image with one or more of a variety of indicia and/or other image(s) for entertainment/amusement and sharing the result with others, wherein the accessed image at the targeted website is not altered in any way.

### BACKGROUND

A number of browsers, such as Internet Explorer and FireFox, for example, presently exist for accessing websites and viewing images available at the targeted website. In many instances, the images are available for printing as well as viewing. However, the present inventor is unaware of any techniques/apparatus for overlaying an image at a targeted website with indicia and/or other images or like items without altering the viewed image and also allowing others to view the image combined with other indicia/items for fun and amusement, for example.

### SUMMARY OF THE INVENTION

The present invention provides method and apparatus for accessing an image at an arbitrary website, and combining indicia and/or other items with the accessed image. The indicia/items may be available from a website of a service provider which stores the indicia/items for use by subscribers. The user accesses a website employing a presently available browser or an email reading application that supports HTML. Application software provided by the present invention is installed in the browser/email reader and includes directions for use to overlay an image at the target website. The possible combinations of images and overlay(s) are limited only by the creativeness of the user.

### BRIEF DESCRIPTION OF THE DRAWINGS

The present invention will be best understood from a consideration of the accompanying detailed description and drawings, in which:

FIG. 1 shows an example of a “marked up” image; and

FIG. 2 is a simplified diagram useful in explaining the operation of the present invention.

### DETAILED DESCRIPTION OF THE INVENTION AND PREFERRED EMBODIMENTS THEREOF

Summary of Internet Website Toolbar and Functionality

The Internet toolbar employed to practice the present invention is a downloadable software application that installs, for example, in any one of the following environments: (1) an Internet browser environment such as Internet Explorer or FireFox; (2) An email client program such as Microsoft's Outlook or Eudora; and (3) an operating system such as Microsoft windows, Linux or Mac OS.

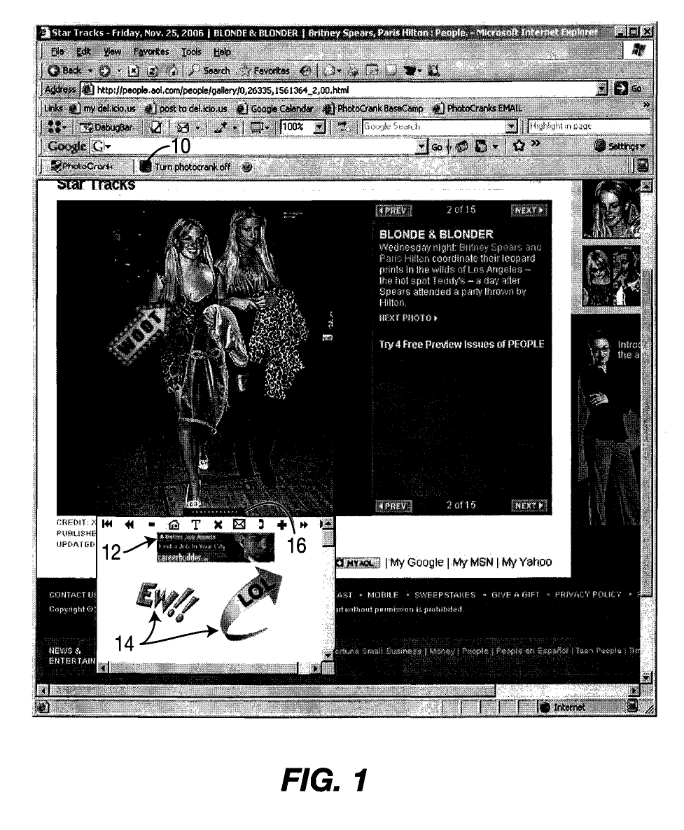

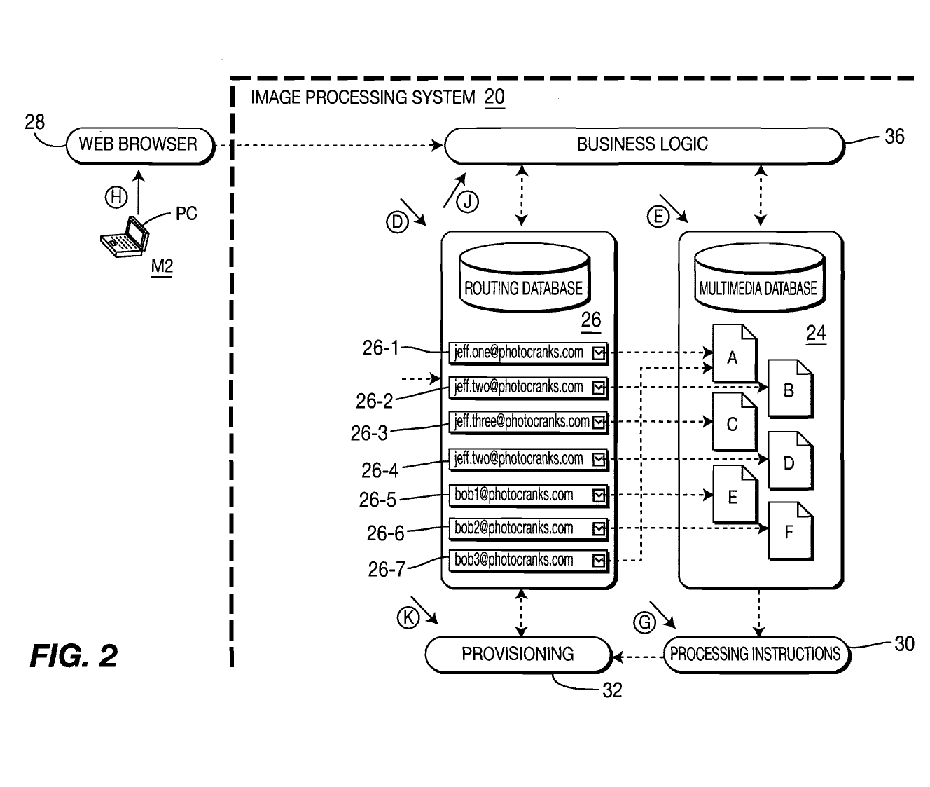

The toolbar, shown in FIG. 1, is integrated into a typical toolbar a “button” to selectively activate a “cranking operation.” The toolbar and browser are typically provided in any suitable device M2, shown in FIG. 2, such as a PC, laptop, Blackberry, etc. The web browser is used to access an image at a targeted website. Operation of button 10 activates the marking up routine. The aforesaid application software provides directions for any of the above-mentioned applications to overlay images on the target website when viewed by a user using an Internet browsing tool such as a standard web browser or an email reading application that supports HTML.

As used herein, a “user” is a person downloading the toolbar and “marking up” an existing website page or image, a “target website” is the website that includes the user's markings, and a “target image” is the image that has been marked. “Marking up” as used herein means overlaying an image from a targeted website with any one of a variety of possible indicia/other images.

The user downloading the toolbar has the ability to utilize the toolbar's software functionality to, for example, “draw over,” “graffiti over,” or otherwise mark-up an image displayed on an existing website page of the targeted website. For example, the user could, using features of the novel toolbar of the present invention, provide whimsical art (either user-generated or provided by the toolbar software) or text to an existing website image as displayed on the user's computer monitor. The user is further able to view other user's mark-ups that have been overlaid on top of an image.

Mark-ups include rich multimedia such as graphics and clip-art, music, sound bytes and Adobe Flash™ animations, which are stored at 24.

The toolbar software provides a “button” or “bar” 16 bordering a target image. Clicking on this button or bar invokes a drop-down menu. The drop-down menu includes, for example, preset images 14, that can be placed over a target image. The drop down menu may also include an advertisement, such as banner ad 12. The field where the mark-ups will appear can be limited to the border or frame of the target image. The advertisements can be contextually relevant to the image that is being marked-up.

A centralized network 20 of computers, such as are shown at 24, 26, store information related to the marked-up web site images. Computer servers incorporated in the centralized network maintain the centralized network infrastructure and further maintain a database, typically residing at 26, and containing information related to (i) the address of the target website, and (ii) information relating to the location of any graphics and/or alteration(s) by a toolbar user. Communication between 24 and 26 is provided through 30 and 32.

A second user (not shown for purposes of simplicity), downloading the internet toolbar at a device having the capability of device M2, is able to view the markings or mark-ups of the first user when viewing the targeted internet website page. Essentially, the software matches the first user's mark-ups with a given image at the target website address location.

When a user downloads the toolbar software, it is automatically installed as an integral part of the user's internet web browser, as can be appreciated from a consideration of FIG. 1. The installation creates toolbar button 16 that can be turned “on” and “off” by button 10. Turning the toolbar button “on” inserts a short string of code into the HTML code of the target website. This code sends a message back through the internet 28 and logic 36 to the centralized network 20 in order to invoke the toolbar functionality. The servers then send code to the user's browser, which is injected into the HTML code on the “client side,” that is, at the user's browser.

The toolbar supports the ability to read the binary data that composes an image and from that data, generates a unique hash code that represents the image. The toolbar uses this hash code to contact the central server and look-up any mark-ups (stored at 24) that have been added to a targeted image that contains a matching hash code. The server at 20 then responds to the toolbar with relevant information pertaining to the markups on the image.

The targeted image and the markups exist only electronically and are combined and displayed only at the user's device M2. A second user can access the marked-up image by activating the second user's mark up routine when the targeted image is brought up by the second user. The stored code provides the second user with the markups, which are combined with the targeted image and displayed by the second user's display screen.

Although the string of code sent to the targeted website resides in the HTML code of that website, the targeted image will be viewed without any markups when accessing that website when accessed using a device which does not have the markup program of the present invention or by using a device whose mark up program is turned off.

What is claimed is:

1. A method for use by a user device and an associated centralized network, said device being configured accessing the centralized network and the Internet and displaying a toolbar and images, for marking up an image obtained from a website, comprising the steps of:
providing a first program in said device, configured to function in a manner of a browser and including a marking up program installed in a toolbar of said device for accessing and obtaining a targeted image at a given website;
activating the marking up program by operating a button as part of the toolbar; and
selecting a markup comprised of at least one of a self-generated markup created by the user, such as by hand, text, and multimedia graphics;
the marking up program providing a given code to the targeted website which is communicated by the targeted website to the centralized network;
the centralized network:
sending code to the user's device which combines the targeted image and said at least one markup for generating a display at the user's device.

2. The method of claim 1, the centralized network storing data representing text, images and indicia available to said user for performing a markup.

3. The method of claim 1, the marking up program creating a button along a border of the targeted image and providing selections for mark up options displayed at said device.

4. The method of claim 1, further comprising the centralized network:
storing data associating the targeted image and mark ups selected by the user enabling a second user accessing the targeted image to view the targeted image and markups responsive to selection of the targeted and associated markups by the second user when employing a second device having a capability of said device.

5. The method of claim 1, the toolbar further comprising:
reading binary data representing the targeted image; and
generating a given code representing the targeted image.

6. The method of claim 5, the toolbar further comprising:
said given code instructing the centralized network to look up any markups added to the targeted image.

7. The method of claim 6, the centralized network further comprising:
responding to the given code with relevant information relating to markups added to the targeted image matching said given code.

8. Apparatus for use by a user device and an associated centralized network, said device being configured accessing the centralized network and the Internet and displaying a toolbar and images, for marking up an image obtained from a website, comprising:
a unit configured to function in a manner of a browser and including a marking up unit installed in a toolbar unit of said device for accessing and obtaining a targeted image at a given website;
a unit for activating the marking up unit including an operating a button provided as part of the toolbar unit; and
a unit for selecting a markup comprised of at least one of a self-generated markup created by the user, such as by hand, text, and multimedia graphics;
the marking up unit being configured to provide a given code to the targeted website which is communicated by the targeted website to the centralized network;
the centralized network comprising:
a unit configured to send code to the user's device which combines the targeted image and said at least one markup for generating a display at the user's device.

9. The apparatus of claim 8, the centralized network comprising a unit for storing data representing text, images and indicia available to said user for performing a markup.

10. The apparatus of claim 8, the marking up unit being configured to create a button along a border of the targeted image and providing selections for mark up options displayed at said device.

11. The apparatus of claim 8, the centralized network further comprising:
a unit configured to store data associating the targeted image and mark ups selected by the user enabling a second user accessing the targeted image to view the targeted image and markups responsive to selection of the targeted and associated markups by the second user when employing a second device having a capability of said first mentioned device.

12. The apparatus of claim 8, the toolbar unit further configured to read binary data representing the targeted image and generate a given code representing the targeted image.

13. The apparatus of claim 12, the centralized network being configured to look up any markups added to the targeted image responsive to said given code.

14. The apparatus of claim 6, the centralized network being further configured to provide relevant information relating to markups added to the targeted image matching said given code responsive to said given code.
